(19) United States
(12) Patent Application Publication
(10) Pub. No.: US 2016/0101548 A1
(43) Pub. Date: Apr. 14, 2016

(54) METHOD FOR COATING FUNCTIONAL COMPONENTS MADE OF PLASTICS MATERIAL

(71) Applicant: AUTOMOBILE PATENTVERWALTUNGS- UND -VERWERTUNGSGESELLSCHAFT MBH, Lüdenscheid (DE)

(72) Inventor: Dirk KIESLICH, Plettenberg (DE)

(73) Assignee: Automobile Patentverwaltungs- und -verwertungsgesellschaft mbH, Luedenscheid (DE)

(21) Appl. No.: 14/786,601

(22) PCT Filed: Apr. 24, 2013
(86) PCT No.: PCT/EP2013/058536

§ 371 Date: Oct. 23, 2015

(51) Int. Cl. B29C 45/14; B29C 37/00; C25D 5/56; C25D 5/02

(52) U.S. Cl. CPC B29C 45/14688; C25D 5/022; B29C 45/14827; B29C 37/0028; C25D 5/56; B29C 2045/14713; B29C 2037/0046; B29K 2055/02

(57) ABSTRACT

A method for coating functional components made of plastics material and having a symbol or the like by electroplating produces the components from an electroplateable plastics material in the injection molding process and then electroplates or metallizes the components, the coated regions of the components remaining free of electroplating. In this process, a print reflecting the symbol or the like is applied to the component, the print of the symbol is provided on a film of material that is not compatible with the material to be back injection molded, preferably the plastics material to be subsequently electroplated, and the printed image provided on the carrier film is permanently transferred from the film to the component in the injection molding process.

The invention relates to a method for coating components having a symbol through which light can pass, or functional components having something similar, made of plastic, in which the component is produced from an electroplatable plastic, using the injection-molding method, and subsequently electroplated or metallized, wherein the coated regions of the components remain electroplate-free.

The functional components made of plastic, of the type being considered here, for example for the automotive industry, are essentially operating elements with which different functions of the vehicle can be displayed and operated. These include, for example, start/stop buttons, operating elements for vehicle lighting, climate control, sliding roofs, convertible tops, or interior lighting. The said components have in common that they have a symbol or words or the like, which describe the respective function. This symbol is configured in a contrast color, in other words in a different color from the remainder of the operating element, for better visibility. Demands on the symbol are, for example, contrast sharpness in comparison with the operating element itself, as well as the ability to be backlit.

Various methods are known for creating the aforementioned functional components made of plastic and having a metallic coating. For example, the PVD method (physical vapor deposition) is based on metallization of an operating element produced from a plastic. In this connection, thin layers are deposited in a vacuum. The material to be deposited is present in solid form. The vaporized material moves through the vacuum chamber and impacts the components to be coated, where layer formation takes place. Subsequent machining with lasers to produce the symbol is disadvantageous, in this connection. It is true that the PVD method is suitable for applying the desired symbol to the components. However, it has proven to be problematical that the metal layer does not have sufficient strength to prevent wear and corrosion, without an additional protective layer. For this reason, it is necessary to apply a protective layer, composed of varnish, for example, in order to satisfy the high demands with regard to adhesion and stability of the coating in the automotive industry, for example. However, the costs are increased by this additional work step. Furthermore, methods are known in which the components are galvanically coated. In this connection, the parts are first produced using the injection-molding method, for example from ABS or ABS/PC. After the injection-molding process, the components are galvanically pre-treated, in order to produce a thin metallic layer. The components are then removed from the electroplating process. After removal, the electroplated metal layer is removed by means of a laser in certain regions. The components treated in this manner are then passed to the electroplating process again, and the electroplating process is continued until the desired chrome layer has been formed. The lasered regions then form the symbol. It is true that using the said methods, it is possible to produced technically and optically high-quality operating elements. However, the method demonstrates the disadvantage that for one thing, the additional work step of laser use to produce the symbol increases the costs. Furthermore, in the aforementioned method, two electroplating processes are required. In total, because of the method sequences that exist, the said method is not suitable for mass-production components.

This is where the invention wishes to provide a remedy. The invention is based on the task of creating a method for coating functional components having a symbol or the like, made of plastic, for the automotive industry, by means of electroplating, which method is cost-advantageous and also suitable for the production of mass-produced products, on the one hand, and on the other hand also makes the required wear resistance of the metal layer of the respective operating elements available without additional treatment. According to the invention, this task is accomplished in that an imprint that reproduces the symbol or the like is applied to the component, that the imprint of the symbol is formed on a film composed of a material that is not compatible with the material to be back-injected, preferably the plastic material that will be electroplated later, and the transfer of the print image situated on the support film, from the film to the component, is performed using the injection-molding process, in permanent manner.

With the invention, a method for coating functional components having a symbol or the like, made of plastic, preferably for the automotive industry, by means of electroplating is created, which is significantly more cost-effective in comparison with the methods known from the state of the art. This is brought about in that only one electroplating process is required, and therefore the design effort for the production line is already reduced in comparison with the known methods. In the galvanic process, in this connection only the uncoated regions are electroplated, while the regions of the transferring imprint remain galvanic-free. Furthermore, interruption of the electroplating process for laser treatment of the components, as known from the state of the art, is not required, so that electroplating can be undertaken in a single, continuous process. In addition, high-quality components, which also meet the requirements, for example regarding wear, can be produced using the method according to the invention.

In a further development of the invention, the symbol is applied using a varnish that cannot be electroplated and is galvanically stable. The use of varnishes has the advantage that the most varied varnishes, having different properties, are available for use, and on the other hand, any desired shapes for symbols, words or numbers can be formed using the varnishes.

Preferably, the symbol is imprinted onto the component by way of the film support. Printing represents a simple method, particularly when using non-electroplatable varnishes to create the symbol, and can furthermore be easily integrated into the remainder of the method sequence.

Extremely preferably, the imprinting of the film is applied to the component during the injection-molding process. With this method of application, the production process can be additionally optimized, because in this case, the injection-molding process is combined with the application of the imprint. In this way, a production station is eliminated from the production process.

In an advantageous further development of the invention, the film is processed using the in-mold decoration method. This is a method in which plastic injection-molded parts produced by means of injection-molding are provided with a decorative layer during injection-molding, wherein the film is preferably drawn into the injection-molding tool and the imprint of the film,. which reproduces the symbol, is transferred to the surface of the plastic injection-molded part over its full area. The layer that forms the symbol can be released from the support film. It furthermore has a heat-activatable wax layer, so that the decorative layer comes. loose from the support film during the injection-molding process, during which very high temperatures prevail within the injection-molding tool, and is transferred to the component to be produced. The adhesion mechanism of the print transferred from the film to the component can be supported by means of a primer system, which is activated by the plastic material that is injected on and ensures permanent adhesion.

Other further developments and embodiments of the invention are indicated in the other dependent claims. An exemplary, embodiment of the invention is shown in the drawings and described in detail below. The figures show:

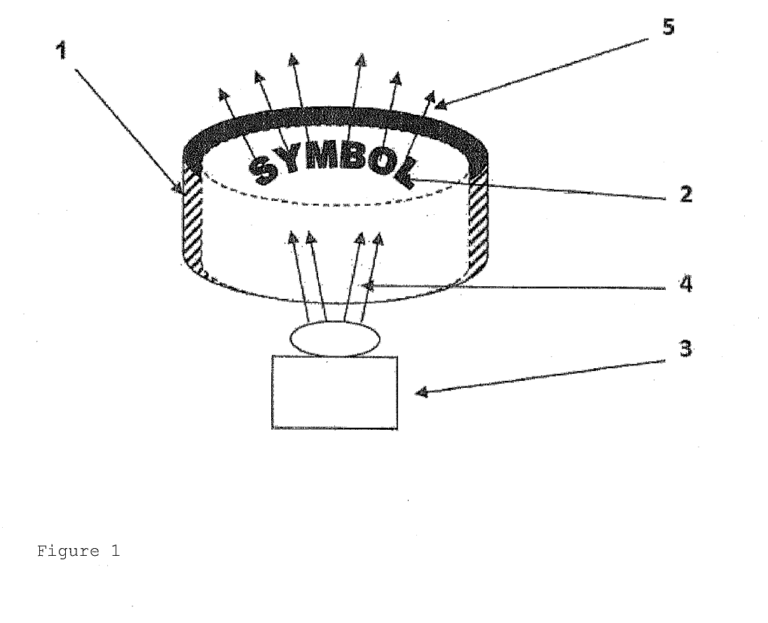

FIG. 1 the schematic representation of a functional component made of plastic, in the form of a start/stop button;

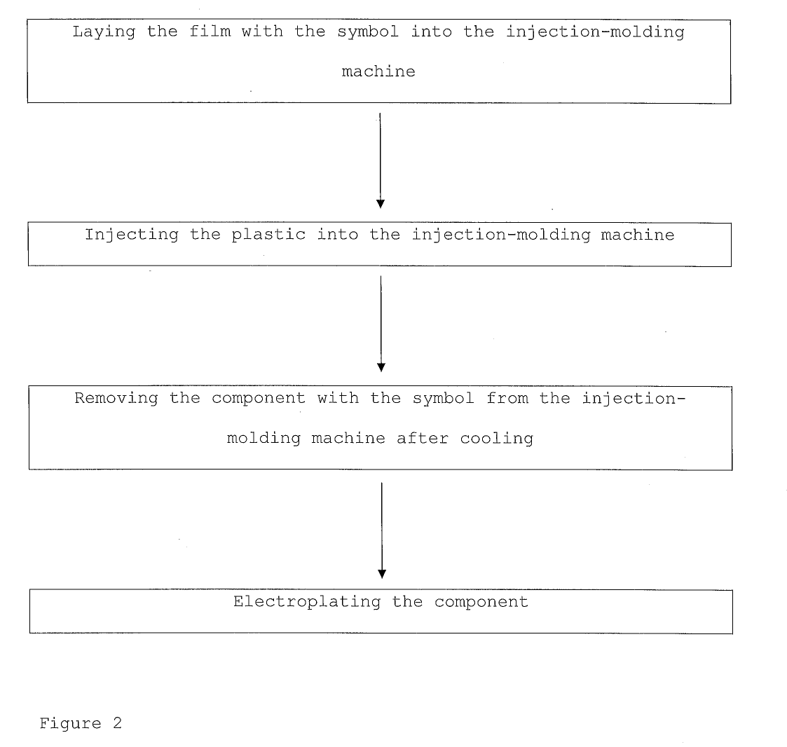

FIG. 2 the flow chart of a method according to the invention;

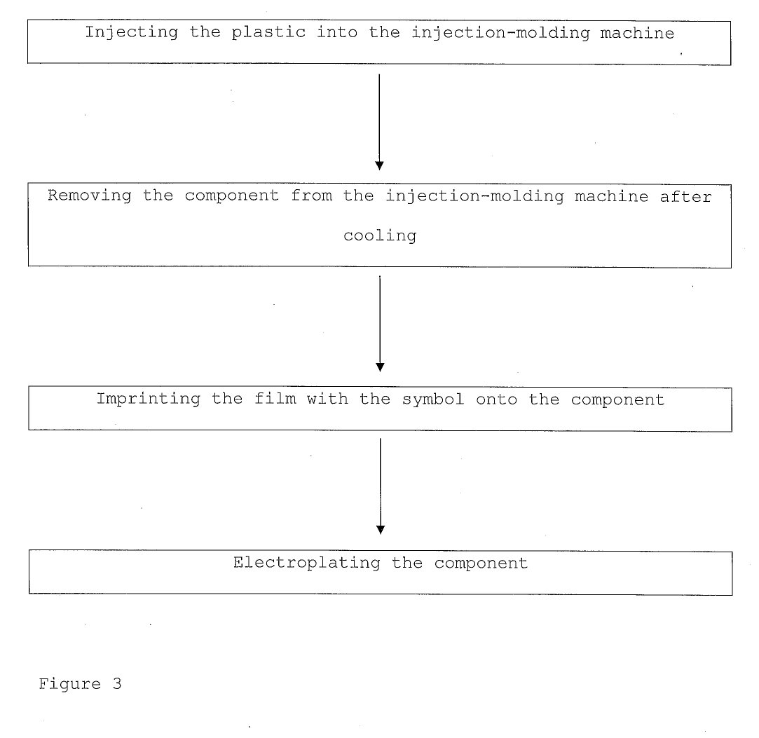

FIG. 3 the flow chart of a method according to the invention in a different embodiment.

The method according to the invention serves for coating functional components 1 made of plastic, by means of electroplating, for example for the automotive industry. The functional components 1 have a symbol 2 after completion of the method, which symbol can involve pictograms, numbers, words or the like. In the exemplary embodiment according to FIG. 1, this is a start/stop button for an automobile, with which the engine of the automobile can be started and shut off. In this case, the symbol 2 consists of the word “symbol.” If other operating elements are involved, the symbol is generally formed in the form of a pictogram, for example the representation of a headlight, if an operating element for vehicle lighting is involved. However, temperature indications, procedure indications or the like are also possible. The component has a metallic multi-layer structure in the exemplary embodiment.

In the method, in the exemplary embodiment according to FIG. 3, first the functional component to be produced from plastic is produced using the injection-molding method. The plastic is an electroplatable plastic, preferably ABS or ABS/PC. Then, a film having the symbol 2 is applied to the component 1. In this connection, the symbol is formed from non-electroplatable material. Preferably, the symbol is applied using non-electroplatable varnish. This can involve PET, PA, COC, PS, POM or polyolefins.

In the exemplary embodiment according to FIG. 2, the symbol is applied during the injection-molding process of the component 1. For this purpose, according to the invention, the in-mold decoration method is used. In this connection, the film, with the symbol situated on it, is drawn through the injection-molding machine. The film is a rolled-up endless film, which is pulled into the injection-molding mold step by step, synchronized with the cycle of the injection-molding machine. Application of the symbol to the endless film takes place, for example, by means of imprinting, preferably by means of intaglio printing. Once the film with the symbol has assumed its predetermined position, the injection-molding mold is closed. Subsequently, the plastic is injected into the injection-molding mold in known manner. Because the film is already situated in the injection-molding mold, it comes into direct contact with the injected plastic. Application of the symbol, using the film, during the injection-molding process, offers the advantage, in terms of process technology, that it is possible to do without a separate processing station for this work step. Processing of the film during the injection-molding process leads, in the case of formation of the film in the manner of a hot-embossing film, for example, that the layer that represents the symbol comes loose from the film during the injection-molding process, because of the high temperatures, and the symbol adheres to the component. After the component cools, the symbol is raised on the component, because the layer that represents the symbol is deposited there and adheres there. The thickness of the applied layer of the symbol, in this connection, amounts to between 1 μm and 15 μm. The adhesion mechanism of the print transferred from the film to the component is supported, in the exemplary embodiment, by a primer system, which is activated by the plastic material that is injected on, and ensures permanent adhesion.

After expiration of the cooling time of the component, the injection-molding apparatus is opened, and the component, with the non-electroplatable layer that forms the symbol, is removed. When the injection-molding apparatus is opened, the film comes loose from the component, while the symbol adheres to the component. The film is then unrolled one step further, so that the region of the film that was freed of the symbol during the injection-molding process leaves the injection-molding mold. In this connection, the film is unrolled to such an extent until the subsequent symbol has assumed its predetermined position.

The component removed from the injection-molding mold can subsequently be roughened by means of pickling, for example, on the side to be electroplated, in order to allow improved adhesion of the materials during electroplating. Then, the component is electroplated. This is done by means of metallization of the surface of the electroplatable side. Electroplating takes place in known manner, by means of physical or electrochemical deposition of multiple metal layers, up to the decorative layer composed of chrome. This chrome layer adheres to the components made of electroplatable plastic, particularly ABS or ABS/PC, without problems. Only the regions provided with the symbol are not coated with chrome, so that because of the different color background of the component, the symbol is evident. Furthermore, the possibility exists of also producing a backlit component in this manner, in that a translucent plastic is used for the component, as shown in FIG. 1. A light source 3 that emits light beams 4 is schematically indicated underneath the component 1. The light beams 4 impact the rear of the component 4 and pass through the translucent plastic in the region of the symbol 2, as symbolized by the arrows 5 in FIG. 1.

Furthermore, the method according to the invention also offers options with regard to the design of the functional components. For example, the possibility exists, by means of coloring the plastic material (ABS or ABS/PC) and decorating it with a dark or black translucent varnish, for example, of producing what is called a day/night design. In the day design, the contrast is formed by the black, selectively open chrome regions in the chrome surroundings, for example; in the night design, passing light through the selectively open chrome regions, through a colored substrate, is possible.

Alternatively, by means of coloring the plastic material (ABS or ABS/PC) and decorating it with a transparent varnish, the possibility exists of presenting a day/night design, using the method according to the invention, in which the contrast is brought about by the color of the open chrome regions in the chrome surroundings, thereby forming the day design. In the night design, an intensification of the color is then created by means of passing light through the selectively open chrome regions of the colored substrate.

1. Method for coating functional components (1) having a symbol (2) or the like, made of plastic, in which the component (1) is produced from an electroplatable plastic, using the injection-molding method, and subsequently electroplated or metallized, wherein the coated regions of the components (1) remain galvanic-free, wherein an imprint that reproduces the symbol (2) or the like is applied to the component (1), the imprint of the symbol (2) is formed on a film composed of a material that is not compatible with the material to be back-injected, preferably the plastic material that will be electroplated later, and the transfer of the print image situated on the support film, from the film to the component, is performed using the injection-molding process, in permanent manner, wherein the film is a rolled-up endless film, which is pulled into the injection-molding mold step by step, synchronized with the cycle of the injection-molding machine.

2. Method according to claim 1, wherein the symbol (2) is applied using non-electroplatable and galvanically stable varnish.

3. Method according to claim 1, wherein the symbol (2) is imprinted onto the component (1) by way of the film support.

4. Method according to claim 1, wherein the imprint on the film is applied to the component (1) during the injection-molding process.

5. Method according to claim 1, wherein the film is processed using the in-mold decoration method.
